(19) United States
(12) Patent Application Publication
(10) Pub. No.: US 2026/0058786 A1
(43) Pub. Date: Feb. 26, 2026

(54) SPECTRUM UTILIZATION FOR WIRELESS COMMUNICATION

(71) Applicant: ZTE CORPORATION, Shenzhen, Guangdong (CN)

(72) Inventors: Jing SHI, Shenzhen (CN); Xianghui HAN, Shenzhen (CN); Xingguang WEI, Shenzhen (CN); Shuaihua KOU, Shenzhen (CN)

(21) Appl. No.: 19/483,260

(22) PCT Filed: May 11, 2023
(86) PCT No.: PCT/CN2023/093690

§ 371 Date: Nov. 11, 2025

(51) Int. Cl. H04L 5/14; H04L 5/00; H04W 72/0453

(52) U.S. Cl. CPC H04L 5/14; H04L 5/0041; H04W 72/0453

(57) ABSTRACT

Wireless communications may include improved flexibility for spectrum utilization. Spectrum utilization may be improved by deriving a flexible or soft band from a combination of multiple bands. The combination may be with bands with the same or different kinds of duplex mode. The flexible or soft band may be utilized in single band operation or by a single cell despite being a combination of bands.

### CROSS-REFERENCE TO RELATED APPLICATIONS

This is a National Stage Application, filed under 35 U.S.C. 371 based on International Patent Application No. PCT/CN2023/093690, filed on May 11, 2023, the disclosure of which is incorporated herein by reference in its entirety.

### TECHNICAL FIELD

This document is directed generally to wireless communications. More specifically, in a mobile device communications system, there may be increased flexibility for spectrum utilization.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfill the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices.

In some embodiments, a method for wireless communication includes deriving a soft band for the wireless communication that comprises multiple bands; and operating with the soft band as a single band operation.

In some embodiments, each of the multiple bands comprises a frequency band and the soft band comprises a combination of frequency bands. Single band operation includes operation over a combination of frequency bands. The multiple bands comprise a combination of different bands. The combination comprises a combination of a Time Division Duplex (TDD) band and a Supplementary Uplink (SUL) band. A single cell with an uplink (UL) carrier and a downlink (DL) carrier is configured based on the combination, further wherein the UL carrier is on the SUL band and the DL carrier is on the TDD band. A UL sub-band is supported in the cell with a bandwidth of the UL sub-band equal to the DL carrier, wherein the UL sub-band is on the TDD band. The combination comprises a combination of a Time Division Duplex (TDD) band and a Supplementary Downlink (SDL) band. A single cell with a downlink (DL) carrier and an uplink (UL) carrier is configured based on the combination, further wherein the DL carrier is on the SDL band and the UL carrier is on the TDD band. A DL sub-band is supported in the cell with a bandwidth of the DL sub-band equal to the UL carrier, wherein the DL sub-band is on the TDD band. The combination comprises a combination of a Frequency Division Duplex (FDD) band and a Supplementary Uplink (SUL) band. A single cell with an uplink (UL) carrier and a downlink (DL) carrier is configured based on the combination, further wherein the UL carrier comprises a non-contiguous spectrum from the both FDD band and SUL band. The combination comprises a combination of a Frequency Division Duplex (FDD) band and a Supplementary Downlink (SDL) band. A single cell with a downlink (DL) carrier and an uplink (UL) carrier is configured based on the combination, further wherein the DL carrier comprises a non-contiguous spectrum from the both FDD band and SDL band. The combination comprises a combination of a Time Division Duplex (TDD) band and a Frequency Division Duplex (FDD) band. A single cell with an uplink (UL) carrier and a downlink (DL) carrier is configured based on the combination, and a DL sub-band is supported in the UL carrier, further wherein the UL carrier is on the both FDD band and TDD band, the DL carrier is on the FDD band, and the DL sub-band is on the TDD band. A single cell with a downlink (DL) carrier and an uplink (UL) carrier is configured based on the combination, and a UL sub-band is supported in the DL carrier, further wherein the DL carrier is on the both FDD band and TDD band, the UL carrier is on the FDD band, and the UL sub-band is on the TDD band. A single cell with a downlink (DL) carrier and two uplink (UL) carriers is configured based on the combination, and a DL sub-band is supported in one of the two UL carriers, further wherein a bandwidth of the DL sub-band equal to the one of the two UL carriers, or the DL sub-band is supported in one of the two UL carriers with a larger spectrum resource. A single cell with two downlink (DL) carriers and one uplink (UL) carrier is configured based on the combination, and a UL sub-band is supported in one of the two DL carriers, further wherein a bandwidth of the UL sub-band equal to the one of the two DL carriers, or the UL sub-band is supported in one of the two DL carriers with a larger spectrum resource. The method includes utilizing a gap of the FDD UL operating band and the FDD DL operating band as the TDD band; or utilizing an overlap of multiple bands by a sub-band. The combination comprises a combination of two Time Division Duplex (TDD) bands. A single cell with an uplink (UL) carrier and a downlink (DL) carrier is configured based on the combination, further wherein the UL carrier is on one of the two bands and the DL carrier is on the other one of the two bands, or both the UL carrier and the DL carrier are on the two bands. At least one of a UL sub-band and a DL sub-band is supported in the cell, wherein the UL sub-band is supported on the DL carrier, the DL sub-band is supported on the UL carrier. A single cell with an uplink (UL) carrier and a downlink (DL) carrier is configured based on the combination, wherein both the UL carrier and the DL carrier are on one of the two bands, the other one of the two bands is configured as sub-band for at least one of the UL carrier and the DL carrier.

In some embodiments, a wireless communications apparatus comprises a processor and a memory, and the processor is configured to read code from the memory and implement any of the embodiments discussed above.

In some embodiments, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causes the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example base station.

FIG. 2 shows an example random access (RA) messaging environment.

FIG. 3 shows a block diagram of an example configuration of a transceiver and antenna.

FIG. 4 shows a block diagram illustrating relationships between carriers, bands, and cells.

FIG. 5 illustrates a symbol/slot structure.

FIG. 6 illustrates a band combination with a Time Division Duplex (TDD) band and a Supplementary Uplink (SUL) band.

FIG. 7 illustrates a band combination with a Time Division Duplex (TDD) band and a Supplementary Downlink (SDL) band.

FIG. 8 illustrates a band combination with a Frequency Division Duplex (FDD) band and a Supplementary Uplink (SUL) band.

FIG. 9 illustrates a band combination with a Frequency Division Duplex (FDD) band and a Supplementary Downlink (SDL) band.

FIG. 10A illustrates an embodiment of a band combination with a Time Division Duplex (TDD) band with a Frequency Division Duplex (FDD) band when the spectrum of the TDD band is higher than the FDD DL operation band.

FIG. 10B illustrates an embodiment of a band combination with a Time Division Duplex (TDD) band with a Frequency Division Duplex (FDD) band when the spectrum of the TDD band is lower than the FDD UL operation band.

FIG. 10C illustrates an embodiment of a band combination with a Time Division Duplex (TDD) band with a Frequency Division Duplex (FDD) band when the spectrum of the TDD band is located in the gap between the FDD UL operation band and the FDD DL operation band.

FIG. 10D illustrates an embodiment of a band combination with a Time Division Duplex (TDD) band with a Frequency Division Duplex (FDD) band when the spectrum of the TDD band includes the FDD UL or DL operation band.

FIG. 11 illustrates a band combination with two Time Division Duplex (TDD) bands.

FIG. 12 shows an embodiment of sub-band full duplex (SBFD) on two bands.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

Wireless or mobile communication technology improvements result in increased demands. Based on the current development trend, systems are developing support on features of enhanced mobile broadband (eMBB), ultra-reliable low-latency communication (URLLC), and massive machine-type communication (mMTC). Full duplex may be a requirement for 5G and subsequent communication systems. In wireless communication, a network device, such as a user equipment (UE), may perform uplink (UL) transmitter (Tx) switching between bands. For multi-carrier operation, a network device that transmits with two transmitters (also called a 2Tx user device), may transmit in two UL bands. Which two bands that are used may be changed by radio resource control (RRC) reconfiguration.

Carrier Aggregation (CA) can be both used in 4G and 5G and future communication systems. Multiple carriers or cells from one or more bands can be configured for capacity improvement with user equipment (UE) capability sharing. UE capabilities are shared within carriers/bands/cells. Uplink (UL) transmission (Tx) switching is an example of a UE capability that is shared between two bands from one transmitter. Allowing the UE capability to be shared improves communications if one carrier or one band is not working at a time or is not working within a period/duration. In another example, if some hardware or software can be shared among bands or carriers, higher UE capability could be achieved for some UE with less cost restriction. UE capability sharing is further described in the embodiments below.

In some wireless communication embodiments, an uplink (UL) symbol or slot may be configured/scheduled to transmit data or control information from a user equipment to a base station; and a downlink (DL) symbol or slot may be configured/scheduled to transmit data or control information from the base station to the UE. In one example, for a time division duplex (TDD) carrier, a DL symbol (or slot) and a UL symbol (or slot) may be time-divisionally configured.

Operating bands may be defined for utilization by the network operator. The definition for one band may include the frequency region and the duplex mode. The duplex mode may include Frequency Division Duplex (FDD), Time Division Duplex (TDD), Supplementary Downlink (SDL), and/or Supplementary Uplink (SUL). In some embodiments, there may be variable duplex FDD, and the FDD band can be generated by a combination SUL band with SDL band. For full duplex, the non-overlapped sub-band full duplex may be considered and at least one UL sub-band can be supported or configured within a TDD carrier. The combinations are described in the embodiments below to improve flexibility for spectrum utilization. This may achieve the benefit of partial or all kinds of duplex mode, such as low latency, high peak rate, better coverage and high reliability, etc.

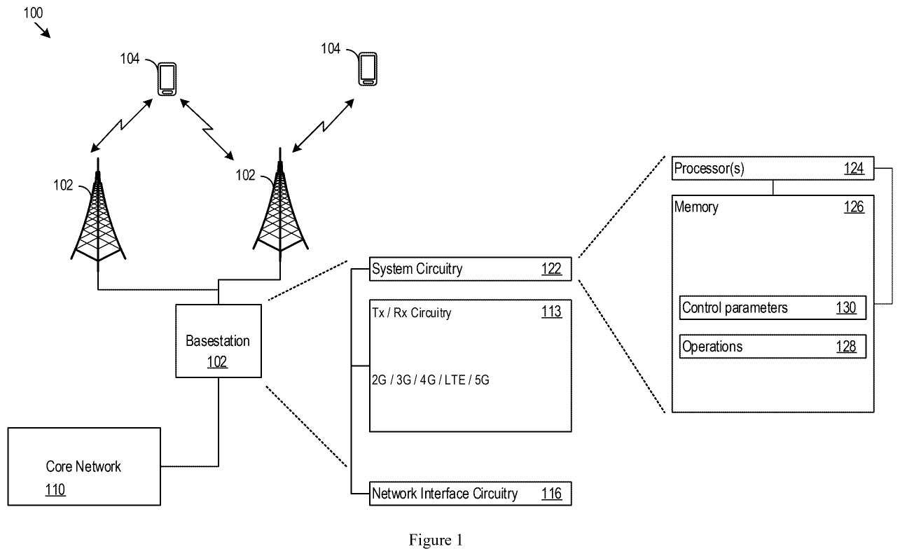

FIG. 1 shows an example base station 102. The base station may also be referred to as a network device or wireless network node. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals. Also, particular signals can be characterized or defined as either an uplink (UL) signal, a downlink (DL) signal, or a sidelink (SL) signal. An uplink signal is a signal transmitted from a UE 104 to a base station 102. A downlink signal is a signal transmitted from a base station 102 to a UE 104. A sidelink signal is a signal transmitted from one UE 104 to another UE 104.

For at least some specifications, such as 5G New Radio (NR), data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signal received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a base station 102 to a UE 104. In other embodiments, the control information includes uplink control information (UCI) that is transmitted in the uplink direction from a UE 104 to a base station 102, or sidelink control information (SCI) that is transmitted in the sidelink direction from one UE 104 to another UE 104.

In addition, in some embodiments, a UE 104 may be configured to support at least one simultaneous UL transmission mode across a band pair for UL transmissions. In a first simultaneous UL transmission mode (also called a switched UL mode), the UE 104 does not support simultaneous UL transmission across a band pair. Accordingly, when the UE 104 transmits a UL transmission in the first simultaneous UL transmission mode, the UE 104 transmits the UL transmission without simultaneously transmitting across a band pair. In addition, in a second simultaneous UL transmission mode (also called a dual UL mode), the UE 104 supports simultaneous UL transmission across a band pair. Accordingly, when the UE 104 transmits a UL transmission in the second simultaneous UL transmission mode, the UE 104 may transmit the UL transmission by simultaneously transmitting across a band pair.

Also, in some embodiments, the UE 104 may report the simultaneous UL transmission mode(s) to the base station 102. That is, the UE 104 may report, to the base station 102, that it supports simultaneous UL transmission across a band pair, that it does not support simultaneous UL transmission across a band pair, or that it both supports and does not support simultaneous UL transmission across a band pair. In particular of these embodiments, the UE 104 may report whether or not it supports simultaneous UL transmission across a band pair per band combination (BC). Also, the base station 102 may be configured in the simultaneous UL transmission mode (e.g., switched UL or dual UL) per cell group, which may be considered as per BC or per band pair in embodiments where a 2Tx user device supports only two bands. That is, one available band pair in a band combination may support one simultaneous UL transmission mode.

Additionally, in general as used herein, a band combination may include a plurality of bands (e.g., five bands). In addition, as used herein, a band group may include up to three or four bands. A given band group may be included in or part of a band combination. Also, a band combination and/or a band group may include at least one band pair, where a band pair includes two bands.

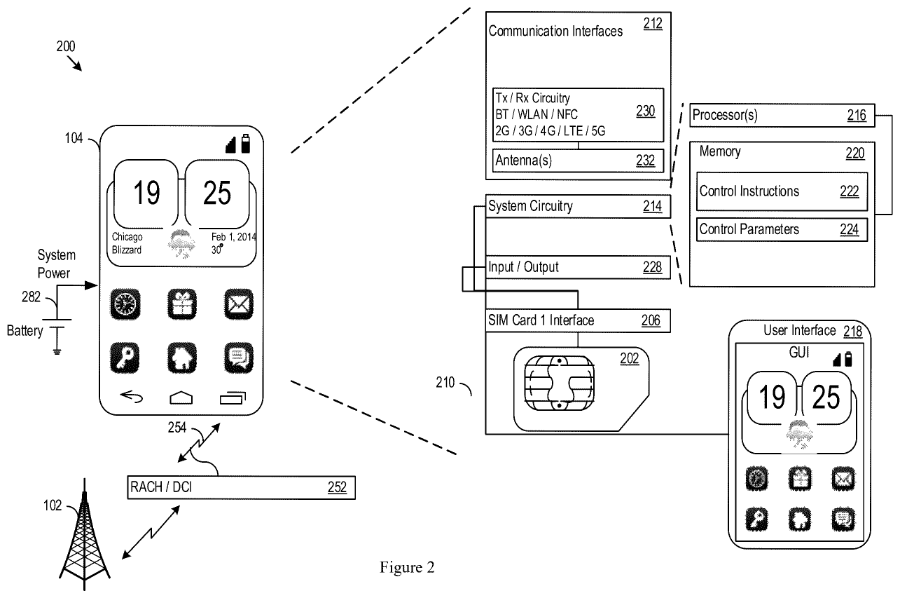

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC.

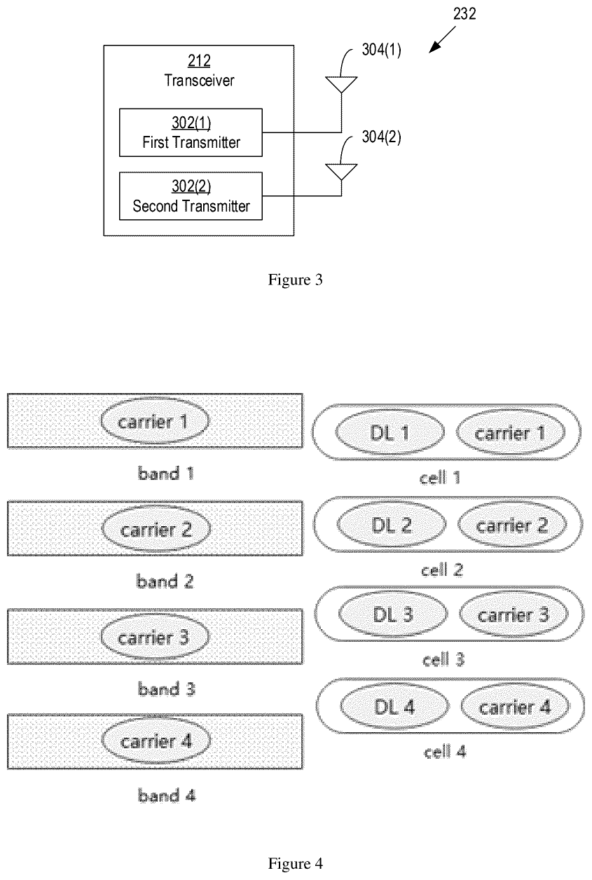

FIG. 3 shows a block diagram of an example configuration of the transceiver 212 and the antenna 232. In particular, the transceiver 212 includes a first transmitter (Tx) (or transmitter circuit) 302(1) and a second transmitter (Tx) (or transmitter circuit) 302(2). In addition, the antenna 232 may include a first antenna component 304(1) and a second antenna component 304(2). In general, the first transmitter 302(1) and the first antenna component 304(1) may form a first transmitter channel or chain, and the second transmitter 302(2) and the second antenna component 304(2) may form a second transmitter channel or chain. A UE 104, with the configuration in FIG. 2, may be configured to transmit a first UL transmission (or a first part of a UL transmission) using the first transmitter channel, and may be configured to transmit a second UL transmission (or a second part of a UL transmission) using the first transmitter channel.

In some embodiments, the UE 104 may use the two transmitter channels to transmit on one or two bands or carriers. The UE 104 may do so in any of various ways. For example, the UE 104 may transmit on a single carrier using both the first transmit channel and the second transmit channel. As another example, the UE 104 may transmit on a first carrier using the first transmit channel and on a second carrier using the second transmit channel. As used herein, the terms “1 Tx” and “1T” refer to use of one channel to transmit on one carrier, and the terms “2 Tx” and “2T” refer to the use of two transmit channels to transmit on one carrier. In addition, as used herein, the phrase “UL transmit case” refers to a particular configuration of the transmit channels used for a UL transmission on one or more carriers. Also, as described in further detail below, the UE 104 may switch between UL transmit cases during a UL Tx switching operation.

In addition, in various embodiments, the UE 104 may perform UL transmitter (Tx) switching to perform UL transmissions. In general, the UE 104 may perform UL Tx switching by switching from one UL transmit case to another UL transmit case. In operation, the UE 104 may transmit a UL transmission according to a first UL transmit case, and then may switch from the first UL transmit case to a second UL transmit case, and transmit a UL transmission according to the second UL transmit case. In addition, in various embodiments, UL transmit cases may also identify numbers of antenna ports corresponding to the carriers. The identification may be in the form of a mapping between carriers and respective numbers of antenna ports. For at least some of these embodiments, the numbers of antennas may depend on whether or not the UE 104 supports simultaneous transmission across a band pair.

FIG. 4 shows a block diagram illustrating relationships between carriers, bands, and cells. Two bands can be configured for UE to do TX switching. The new radio (NR) structure may be designed to operate in the operating bands defined for FR1 and FR2. For example, several bands in FR1 are shown in Table 1 below with a corresponding frequency region and duplex mode.

TABLE 1
Operating Bands.

| | Uplink (UL) | Downlink (DL) | |
|---|---|---|---|
| NR | operating band | operating band | |
| operating | BS receive/UE transmit | BS transmit/UE receive | Duplex |
| band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n41 | 2496 MHz-2690 MHz | 2496 MHz-2690 MHz | TDD |
| n76 | N/A | 1427 MHz-1432 MHz | SDL |
| n82 | 832 MHz-862 MHz | N/A | SUL |
| n91 | 832 MHz-862 MHz | 1427 MHz-1432 MHz | FDD |

For subband full duplex (SBFD), the uplink (UL) sub-band can be supported or configured within the downlink slots/symbols in a TDD carrier. Based on the Rel-16 variable duplex, n91 may be generated by combination SUL n82 with SDL n76. As described herein, there may be a soft or flexible band which is a combination of one or more bands with same or different kinds of duplex mode. The combination embodiments may be utilized even in single band operation.

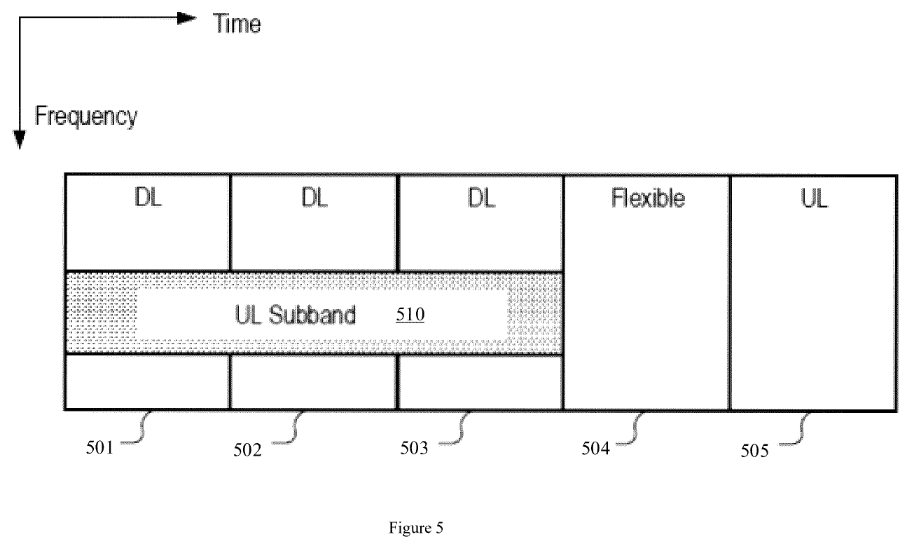

FIG. 5 illustrates a symbol/slot structure. The example shown is a DDDSU (501, 502, 503, 504, and 505). In this example, D represents a DL symbol/slot, U represents a UL symbol/slot, and S represents a flexible symbol/slot, which contains DL symbols and UL symbols. As shown, UL slots are fewer and discontinuous, and the characteristics affect the performance of UL transmission. In some embodiments, a full-duplex technology based on the UL subband may be implemented as subband full duplex (SBFD). FIG. 5 shows one type of the configuration pattern of the UL subband, wherein a UL subband 510 is configured in DL symbols/slots. In some embodiments, the UL subbands may be configured in some or all DL symbols/slots.

This application relates to methods, systems, and devices for increasing flexibility for spectrum utilization. Spectrum utilization may be improved by deriving a flexible or soft band from a combination of multiple bands. The combination may be with bands with the same or different kinds of duplex mode. The flexible or soft band may be utilized as a single band operation or by a single cell despite being a combination of bands. The combination of bands may refer to a combination of different frequencies.

The embodiments described below illustrate various combinations of bands into a single flexible or soft band. For simplicity, the derived band may be referred to as a soft band, but includes a combination of bands (including for single band operation) and may also be referred to as a flexible band or combination band. As described, reference to a combination band may include single band operation.

### Combination of TDD and SUL

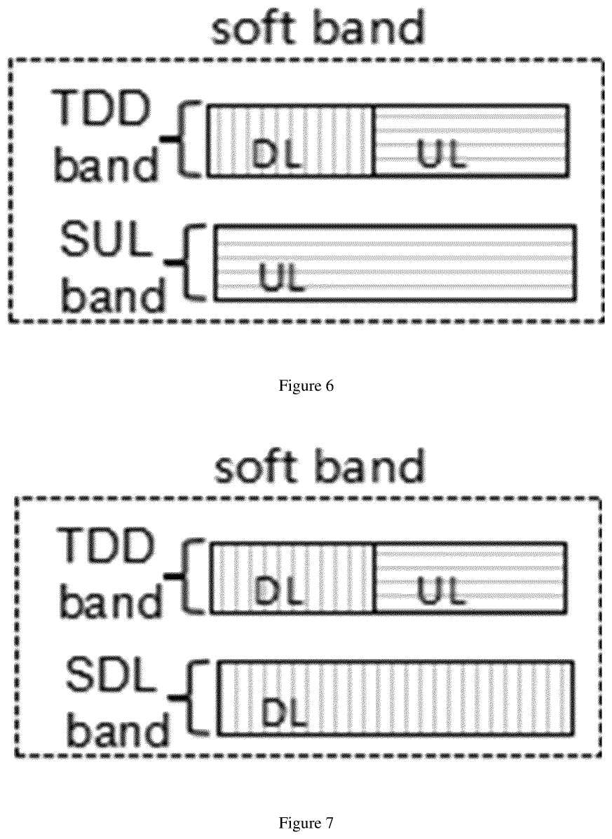

FIG. 6 illustrates a band combination with a Time Division Duplex (TDD) band and a Supplementary Uplink (SUL) band. In this embodiment, the combination of a TDD band and a SUL band is performed as single band operation, rather than being performed as two carriers on two bands. The combination derives a soft or flexible band in which, there is only one downlink (DL) carrier and one uplink (UL) carrier for a cell which is operated on the band.

In some embodiments, the flexible/soft band can be operated by one cell. The single cell may include a UL carrier and a UL sub-band. The bandwidth of the UL sub-band may be equal to the TDD DL carrier. There may be a variable TDD band with UL sub-band support and equal to the DL carrier bandwidth. In some embodiments, the single cell may include a soft UL carrier which comprises the non-contiguous frequency resource from the SUL band and TDD band, optionally by one BWP or multiple BWP.

The flexible/soft band includes both UL and DL operating bands. The DL operating band may be configured with UL slots/symbols or UL sub-band. The UL carrier may be located on the UL operating band, and DL carrier and UL sub-band may be located on the DL operating band. The spectrum of the UL operating band and DL operating band may be different.

In this embodiment, the flexible/soft band is derived by combination of a TDD band and a SUL band, which can provide higher system spectrum efficiency compared with a legacy TDD in which both UL coverage and capacity can be improved.

### Combination of TDD and SDL

FIG. 7 illustrates a band combination with a Time Division Duplex (TDD) band and a Supplementary Downlink (SDL) band. In this embodiment, the combination of a TDD band and a SDL band is performed as single band operation, rather than being performed as two carriers on two bands. The combination derives a soft or flexible band in which, there is only one downlink (DL) carrier and one uplink (UL) carrier for a cell which is operated on the band.

In some embodiments, the flexible/soft band can be operated by one cell. The single cell may include a DL carrier and a DL sub-band. The bandwidth of the DL sub-band may be equal to the TDD UL carrier. There may be a variable TDD band with DL sub-band support and equal to the UL carrier bandwidth. In some embodiments, the single cell may include a soft DL carrier which comprises the non-contiguous frequency resource from the SDL band and TDD band, optionally by one BWP or multiple BWP.

The flexible/soft band includes both UL and DL operating bands. The UL operating band may be configured with DL slots/symbols or DL sub-band. The UL carrier and DL sub-band may be located on the UL operating band. The DL carrier may be located on the DL operating band. The spectrum of the UL operating band and DL operating band may be different.

In this embodiment, the flexible/soft band is derived by combination of a TDD band and a SDL band, which can provide higher system spectrum efficiency compared with a TDD system and can provide benefits when DL traffic is heavy.

### Combination of FDD and SUL

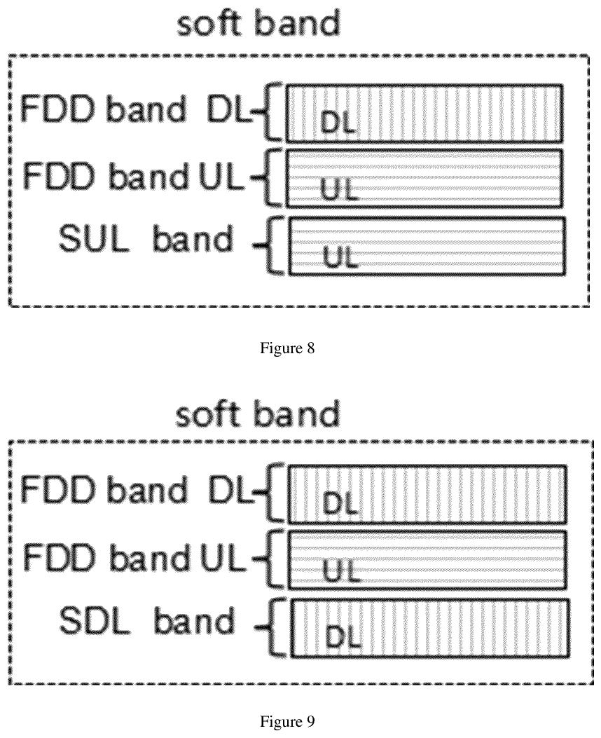

FIG. 8 illustrates a band combination with a Frequency Division Duplex (FDD) band and a Supplementary Uplink (SUL) band. In this embodiment, the combination of a FDD band and a SUL band is performed as single band operation, rather than being performed as two carriers on two bands. The combination derives a soft or flexible band in which, there is only one downlink (DL) carrier and one uplink (UL) carrier for a cell which is operated on the band.

In some embodiments, the flexible/soft band can be operated by one cell. The single cell may include a non-contiguous UL operating band or may be derived by combining multiple UL operating bands. The UL carrier or UL BWP may be located on the UL operating band, and may support non-contiguous frequency resources. In some embodiments, there may be a variable FDD band with UL BWP supported non-contiguous frequency resources. In some embodiments, the single cell may include a soft UL carrier which comprises the non-contiguous frequency resource from the SUL band and FDD band, optionally by one BWP or multiple BWP.

The flexible/soft band includes both UL and DL operating bands. The UL operating band may be configured as a non-contiguous UL operation band or derived by combining multiple UL operating bands. The UL carrier or UL BWP may be located on the UL operating band, and could support non-contiguous frequency resources. The spectrum of the UL operating band and DL operating band may be different.

In this embodiment, the flexible/soft band is derived by combination of a FDD band and a SUL band, which can provide higher system spectrum efficiency compared with other FDD and both UL coverage and capacity can be improved.

### Combination of FDD and SDL

FIG. 9 illustrates a band combination with a Frequency Division Duplex (FDD) band and a Supplementary Downlink (SDL) band. In this embodiment, the combination of a FDD band and a SDL band is performed as single band operation, rather than being performed as two carriers on two bands. The combination derives a soft or flexible band in which, there is only one downlink (DL) carrier and one uplink (UL) carrier for a cell which is operated on the band.

In some embodiments, the flexible/soft band can be operated by one cell. The single cell may include a non-contiguous DL carrier, where the spectrum of the DL carrier includes a non-contiguous DL operating band or multiple DL operating bands. The DL carrier or DL BWP may located on the DL operating band, and may support non-contiguous frequency resources. In some embodiments, the single cell may include a soft DL carrier which comprises the non-contiguous frequency resource from the SDL band and FDD band, optionally by one BWP or multiple BWP.

The flexible/soft band includes both UL and DL operating bands. The DL operating band may be configured as a non-contiguous UL operation band or derived by combining multiple DL operating bands. The DL carrier or DL BWP may be located on the DL operating band, and could support non-contiguous frequency resources. The spectrum of the UL operating band and DL operating band may be different.

In this embodiment, the flexible/soft band is derived by combination of a FDD band and a SDL band, which can provide higher system spectrum efficiency compared with a FDD system and can provide benefits when DL traffic is heavy.

### Combination of FDD and TDD

The combination of FDD and TDD can be made with operation still in a single cell. The embodiments described below include single cell operation with the combination of the FDD band and the TDD band.

In one embodiment, there may be a combination of a TDD band and FDD UL operating band. This may be similar to the operation for the combination of a TDD band and SUL band as illustrated in FIG. 6 and described above. In this embodiment, the combination of a TDD band and a FDD UL operating band is performed as single band operation, rather than being performed as two carriers on two bands. The combination derives a soft or flexible band in which, there is only one downlink (DL) carrier and one uplink (UL) carrier for a cell which is operated on the band. The flexible/soft band can be operated by one cell. The single cell may include a UL carrier and a UL sub-band. The bandwidth of the UL sub-band may be equal to the TDD DL carrier. There may be a variable TDD band with UL sub-band support and equal to the DL carrier bandwidth. The UL carrier may be located on the UL operating band, and DL carrier and UL sub-band may be located on the DL operating band. The spectrum of the UL operating band and DL operating band may be different. In this embodiment, the flexible/soft band is derived by combination of a TDD band and a FDD UL operating band, which can provide higher system spectrum efficiency compared with a TDD or FDD system in which both UL coverage and capacity can be improved.

In another embodiment, there may be a combination of a TDD band and FDD DL operating band. This may be similar to the operation for the combination of a TDD band and SDL band as illustrated in FIG. 7 and described above. In this embodiment, the combination of a TDD band and a FDD DL operating band is performed in single band operation, rather than being performed as two carriers on two bands. The combination derives a soft or flexible band in which, there is only one downlink (DL) carrier and one uplink (UL) carrier for a cell which is operated on the band. The flexible/soft band can be operated by one cell. The single cell may include a DL carrier and a DL sub-band. The bandwidth of the DL sub-band may be equal to the TDD UL carrier. The flexible/soft band includes both UL and DL operating bands. The UL operating band may be configured with DL slots/symbols or DL sub-band. The UL carrier and DL sub-band may be located on the UL operating band. The DL carrier may be located on the DL operating band. The spectrum of the UL operating band and DL operating band may be different. In this embodiment, the flexible/soft band is derived by combination of a TDD band and a FDD DL operating band, which can provide higher system spectrum efficiency compared with a TDD or FDD system and can provide benefits when DL traffic is heavy.

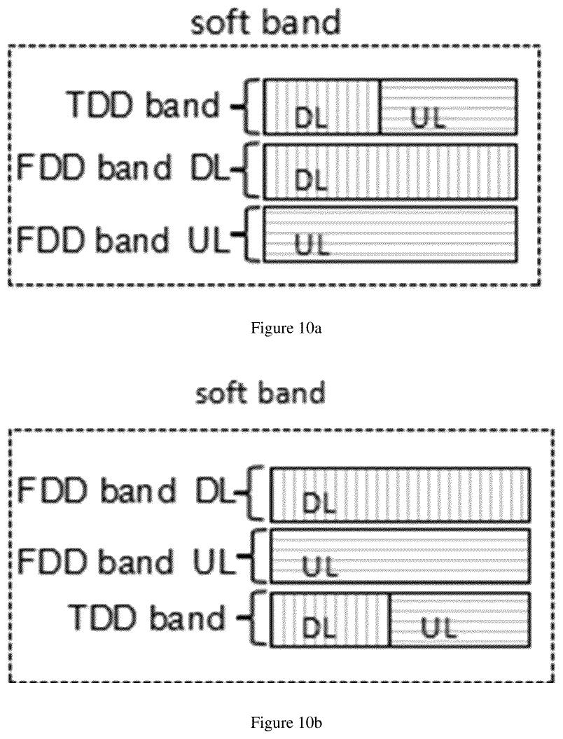

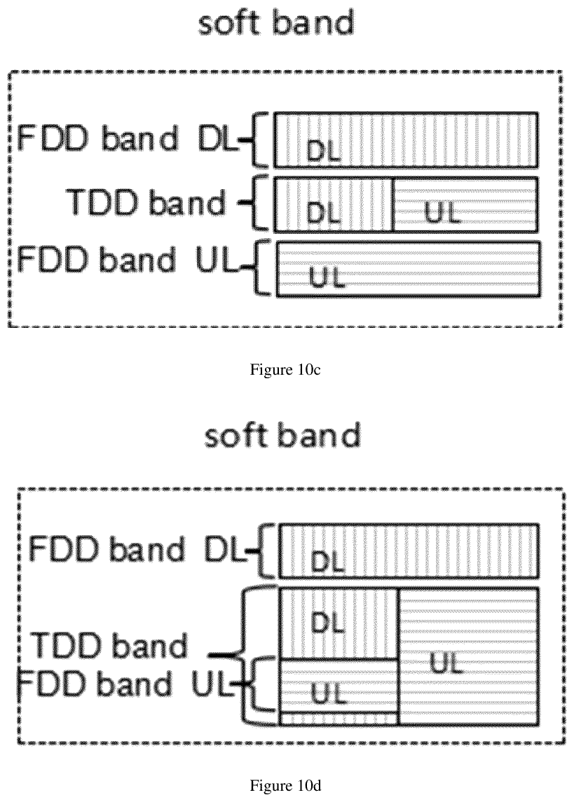

FIGS. 10A-10D illustrate alternative embodiments with a combination of a TDD band and a FDD band. In these embodiments, the combination of a TDD band and a FDD band is performed as single band operation, rather than being performed as two carriers on two bands or only when the spectrum of TDD band is higher than the FDD DL operation band. The combination derives a soft or flexible band in which, there is only one downlink (DL) carrier and one uplink (UL) carrier for a cell which is operated on the band.

FIG. 10A illustrates an embodiment of a band combination with a Time Division Duplex (TDD) band with a Frequency Division Duplex (FDD) band when the spectrum of the TDD band is higher than the FDD DL operation band.

In some embodiments, the single cell includes a DL carrier and a UL carrier, with DL (or UL) sub-band supported/configured in the UL (or DL) carrier. There may be a variable FDD band with DL BWP and/or UL BWP supporting non-contiguous frequency resources. In some embodiments, the single cell may include a soft UL or DL carrier which comprises the non-contiguous frequency resource from the TDD band and FDD band, optionally by one BWP or multiple BWP.

In some embodiments, the single cell includes a DL carrier and two UL carriers (or two DL carriers and one UL carrier), with a DL (or UL) sub-band located in one of the two UL (or DL) carriers. The bandwidth of the DL (or UL) sub-band may be equal to the UL (or DL) carrier configured/supported with the DL (or UL) sub-band. There may be a variable FDD band with DL BWP and/or UL BWP supporting non-contiguous frequency resources. One BWP could be used with partial or all frequency resources of two carriers.

FIG. 10B illustrates an embodiment of a band combination with a Time Division Duplex (TDD) band with a Frequency Division Duplex (FDD) band when the spectrum of the TDD band is lower than the FDD UL operation band.

In some embodiments, the single cell includes a DL carrier and a UL carrier, with DL (or UL) sub-band supported/configured in the UL (or DL) carrier. There may be a variable FDD band with DL BWP and/or UL BWP supporting non-contiguous frequency resources.

In some embodiments, the single cell includes a DL carrier and two UL carriers (or two DL carriers and one UL carrier), with a DL (or UL) sub-band located in one of the two UL (or DL) carriers. The bandwidth of the DL (or UL) sub-band may be equal to the UL (or DL) carrier configured/supported with the DL (or UL) sub-band. There may be a variable FDD band with DL BWP and/or UL BWP supporting non-contiguous frequency resources. One BWP could be used with partial or all frequency resources of two carriers.

FIG. 10C illustrates an embodiment of a band combination with a Time Division Duplex (TDD) band with a Frequency Division Duplex (FDD) band when the spectrum of the TDD band is located in the gap between the FDD UL operation band and the FDD DL operation band.

In some embodiments, the single cell includes a DL carrier and a UL carrier, with DL (or UL) sub-band supported/configured in the UL (or DL) carrier. There may be a variable FDD band with DL BWP and/or UL BWP supporting non-contiguous frequency resources.

In some embodiments, the single cell includes a DL carrier and two UL carriers (or two DL carriers and one UL carrier), with a DL (or UL) sub-band located in one of the two UL (or DL) carriers. The bandwidth of the DL (or UL) sub-band may be equal to the UL (or DL) carrier configured/supported with the DL (or UL) sub-band. There may be a variable FDD band with DL BWP and/or UL BWP supporting non-contiguous frequency resources. One BWP could be used with partial or all frequency resources of two carriers.

In some embodiments, the gap of FDD UL operating band and DL operating or the overlapped operating bands by SBFD may be used to achieve more flexible band utilization. The flexible/soft band may include a UL and DL operating band. The DL (or UL) operating band may be a non-contiguous DL (or UL) operating band or may be derived by combining multiple DL (or UL) operating bands. The DL (or UL) carrier or DL (or UL) BWP may be located on the DL (or UL) operating band, and may support non-contiguous frequency resources. The spectrum of the UL operating band and DL operating band may be the same or may be different. The flexible/soft band is derived by combination of a FDD band and a TDD band for higher system spectrum efficiency compared with legacy combinations by utilizing the gap of FDD band or overlapped DL/UL operating bands.

FIG. 10D illustrates an embodiment of a band combination with a Time Division Duplex (TDD) band with a Frequency Division Duplex (FDD) band when the spectrum of the TDD band includes the FDD UL or DL operation band.

In some embodiments, the gap of FDD UL operating band and DL operating or the overlapped operating bands by SBFD may be used to achieve more flexible band utilization. The flexible/soft band may include a UL and DL operating band. The DL (or UL) operating band may be a non-contiguous DL (or UL) operating band or may be derived by combining multiple DL (or UL) operating bands. The DL (or UL) carrier or DL (or UL) BWP may be located on the DL (or UL) operating band, and may support non-contiguous frequency resources. The spectrum of the UL operating band and DL operating band may be the same or may be different. The flexible/soft band is derived by combination of a FDD band and a TDD band for higher system spectrum efficiency compared with legacy combinations by utilizing the gap of FDD band or overlapped DL/UL operating bands.

In some embodiments, the single cell includes two DL carrier and one UL carrier, with a UL sub-band located in one DL carrier with a larger spectrum resource. There may be a variable FDD band with DL BWP supporting non-contiguous frequency resources. One BWP could be used with partial or all frequency resources of two carriers.

### Combination of TDD and TDD

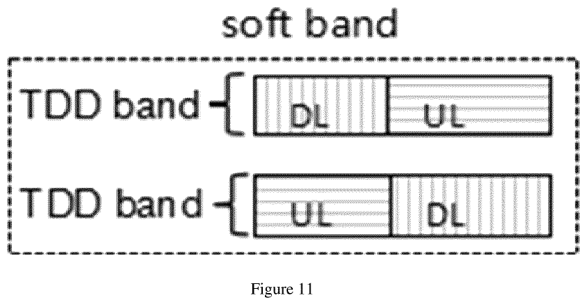

FIG. 11 illustrates a band combination with two Time Division Duplex (TDD) bands. The combination of one TDD band with another TDD band can be made with operation still as a single cell. The embodiments described below include single cell operation with the combination of two TDD bands, rather than being performed as two carriers on two bands. The combination derives a soft or flexible band in which, there is only one downlink (DL) carrier and one uplink (UL) carrier for a cell which is operated on the band.

In some embodiments, the flexible/soft band can be operated by one cell which includes a DL carrier and UL carrier, and a UL sub-band and a DL sub-band. The bandwidth of the DL sub-band may be equal to the UL carrier. The bandwidth of the UL sub-band may be equal to the DL carrier. There may be a variable FDD band with DL sub-band supported and equal to UL carrier bandwidth, and the UL sub-band is supported and equal to DL carrier bandwidth. In some embodiments, the flexible/soft band may be a variable FDD and include UL and DL operating bands. The UL operating band may be configured with DL slots/symbols or DL sub-band, and the DL operating band may be configured with UL slots/symbols or UL sub-band. The UL carrier and DL sub-band may be located on the UL operating band, and DL carrier and UL sub-band may be located on the DL operating band. The spectrum of the UL operating band and DL operating band may be different. The bandwidth of the DL sub-band may be equal to the UL carrier. The bandwidth of the UL sub-band may be equal to the DL carrier.

In some embodiments, one carrier/band may be the sub-band full duplex (SBFD) configured for another carrier/band. A single carrier in one flexible/soft band may include two TDD bands, with the second TDD band configured as SBFD in the carrier of the first band. This may be achieved by BWP based SBFD. This may be through two BWP operations and the single TDD carrier is the aggregated carrier of the two bands, or it may be achieved with a BWP configured for one TDD band and SBFD configured corresponding to the other TDD band which is outside of the BWP. The flexible/soft band may be a variable TDD with both UL-band and DL sub-band configured and supported. The DL sub-band and the UL sub-band are configured outside of the TDD carrier. The flexible/soft band is derived by combination of a TDD band and another TDD band. Higher system spectrum efficiency may be derived compared with just TDD and there may be low latency for both DL traffic and UL traffic. In some embodiments, the single cell may include at least one of soft UL carrier and soft DL carrier which comprise the non-contiguous frequency resource from the two TDD bands, optionally by one BWP or multiple BWP.

Further, the embodiments described above can be used for idle state and cell management may be simplified with the single cell operation.

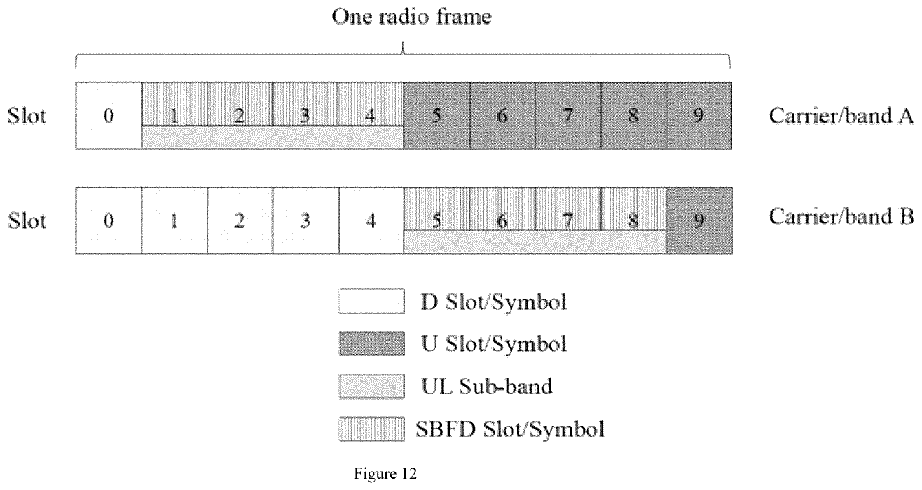

There may be embodiments with a single band or with multiple bands. In order to use a duplexer more efficiently, duplexer sharing within single band for sub-band full duplex (SBFD) or multiple bands may be supported. For SBFD in a TDD carrier that is supported by the base station, the UE may still perform as TDD or HD-FDD, and the UE may have no need for a duplexer. When SBFD in a TDD carrier is supported by the UE, one duplexer may be shared used between SBFD symbols and non-SBFD symbols. For example, in the time duration of sub-band part or SBFD symbols, the duplexer may be used as FDD for DL sub-band and UL sub-band. In the other time duration part or non-SBFD symbols, the duplexer may be used as a switch for legacy TDD for D/U switch. Alternatively, where multiple bands for inter-band CA, with one or more bands with SBFD are configured/supported there may be duplexer sharing among bands. FIG. 12 shows an embodiment of sub-band full duplex (SBFD) on two bands. This may include SBFD on two bands. For example, for complementary SBFD with the SBFD symbols or a duration configured with UL sub-band in one carrier on one band, is not overlapped in time domain with the SBFD symbols or a duration configured with UL sub-band in another carrier on another band. There may be a switch for each TDD carrier/band, and one duplexer is sharing the SBFD symbols duration between the two bands with complementary SBFD symbols on the two bands.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device is designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software-based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
deriving a soft band for the wireless communication that comprises multiple bands; and
operating with the soft band as a single band or single cell operation.

2. The method of claim 1, wherein each of the multiple bands comprises a frequency band and the soft band comprises a combination of frequency bands.

3. The method of claim 2, wherein the single band or single cell operation includes operation over a combination of frequency bands.

4. The method of claim 1, wherein the multiple bands comprise a combination of different bands.

5. The method of claim 4, wherein the combination comprises a combination of a Time Division Duplex (TDD) band and a Supplementary Uplink (SUL) band.

6. The method of claim 5, wherein a single cell with an uplink (UL) carrier and a downlink (DL) carrier is configured based on the combination, further wherein the UL carrier is on the SUL band and the DL carrier is on the TDD band; and
a UL sub-band is supported in the cell with a bandwidth of the UL sub-band equal to the DL carrier, wherein the UL sub-band is on the TDD band.

7. (canceled)

8. The method of claim 4, wherein the combination comprises a combination of a Time Division Duplex (TDD) band and a Supplementary Downlink (SDL) band.

9. The method of claim 8, wherein a single cell with a downlink (DL) carrier and an uplink (UL) carrier is configured based on the combination, further wherein the DL carrier is on the SDL band and the UL carrier is on the TDD band; and
a DL sub-band is supported in the cell with a bandwidth of the DL sub-band equal to the UL carrier, wherein the DL sub-band is on the TDD band.

10. (canceled)

11. The method of claim 4, wherein the combination comprises a combination of a Frequency Division Duplex (FDD) band and a Supplementary Uplink (SUL) band.

12. The method of claim 11, wherein a single cell with an uplink (UL) carrier and a downlink (DL) carrier is configured based on the combination, further wherein the UL carrier comprises a non-contiguous spectrum from the both FDD band and SUL band.

13. The method of claim 4, wherein the combination comprises a combination of a Frequency Division Duplex (FDD) band and a Supplementary Downlink (SDL) band.

14. The method of claim 13, wherein a single cell with a downlink (DL) carrier and an uplink (UL) carrier is configured based on the combination, further wherein the DL carrier comprises a non-contiguous spectrum from the both FDD band and SDL band.

15. The method of claim 4, wherein the combination comprises a combination of a Time Division Duplex (TDD) band and a Frequency Division Duplex (FDD) band.

16. The method of claim 15, wherein one of the following configurations is satisfied:
a single cell with an uplink (UL) carrier and a downlink (DL) carrier is configured based on the combination, and a DL sub-band is supported in the UL carrier, further wherein the UL carrier is on the both FDD band and TDD band, the DL carrier is on the FDD band, and the DL sub-band is on the TDD band;
a single cell with a downlink (DL) carrier and an uplink (UL) carrier is configured based on the combination, and a UL sub-band is supported in the DL carrier, further wherein the DL carrier is on the both FDD band and TDD band, the UL carrier is on the FDD band, and the UL sub-band is on the TDD band;
a single cell with a downlink (DL) carrier and two uplink (UL) carriers is configured based on the combination, and a DL sub-band is supported in one of the two UL carriers, further wherein a bandwidth of the DL sub-band equal to the one of the two UL carriers, or the DL sub-band is supported in one of the two UL carriers with a larger spectrum resource; or
a single cell with two downlink (DL) carriers and one uplink (UL) carrier is configured based on the combination, and a UL sub-band is supported in one of the two DL carriers, further wherein a bandwidth of the UL sub-band equal to the one of the two DL carriers, or the UL sub-band is supported in one of the two DL carriers with a larger spectrum resource.

17. (canceled)

18. (canceled)

19. (canceled)

20. The method of claim 15, further comprising:
utilizing a gap of the FDD UL operating band and the FDD DL operating band as the TDD band; or
utilizing an overlap of multiple bands by a sub-band.

21. The method of claim 4, wherein the combination comprises a combination of two Time Division Duplex (TDD) bands.

22. The method of claim 21, wherein a single cell with an uplink (UL) carrier and a downlink (DL) carrier is configured based on the combination, further wherein the UL carrier is on one of the two bands and the DL carrier is on the other one of the two bands, or both the UL carrier and the DL carrier are on the two bands; and
at least one of a UL sub-band and a DL sub-band is supported in the cell, wherein the UL sub-band is supported on the DL carrier, the DL sub-band is supported on the UL carrier.

23. (canceled)

24. The method of claim 21, wherein a single cell with an uplink (UL) carrier and a downlink (DL) carrier is configured based on the combination, wherein both the UL carrier and the DL carrier are on one of the two bands, the other one of the two bands is configured as sub-band for at least one of the UL carrier and the DL carrier.

25. A wireless communications apparatus comprising a processor and a memory, wherein the processor is configured to read code from the memory and is further configured to:
derive a soft band for the wireless communication that comprises multiple bands; and
operate with the soft band as a single band operation.

26. A computer program product comprising a computer-readable program medium code stored thereupon, the code, when executed by a processor, causing the processor to:
derive a soft band for the wireless communication that comprises multiple bands; and
operate with the soft band as a single band operation.
